(19) United States
(12) Patent Application Publication
(10) Pub. No.: US 2014/0269987 A1
(43) Pub. Date: Sep. 18, 2014

(54) COMBINED MULTI-STAGE CREST FACTOR REDUCTION AND INTERPOLATION OF A SIGNAL

(71) Applicant: QUALCOMM Incorporated, San Diego, CA (US)

(72) Inventors: Arik Gubeskys, Hod Hasharon (IL); Assaf Touboul, Netanya (IL)

(73) Assignee: QUALCOMM Incorporated, San Diego, CA (US)

(21) Appl. No.: 14/201,403

(22) Filed: Mar. 7, 2014

Related U.S. Application Data
(60) Provisional application No. 61/784,426, filed on Mar. 14, 2013.
(60) Provisional application No. 61/809,743, filed on Apr. 8, 2013.

(51) Int. Cl. H04B 1/04

(52) U.S. Cl. CPC H04B 1/0475
USPC 375/296

(57) ABSTRACT

Methods, systems, and apparatuses are described for performing combined crest factor reduction and interpolation on a signal to be transmitted on a wireless channel. A sample based on a signal to be transmitted on a wireless channel may be received at each stage of a plurality of cascaded stages in a transmitter of a wireless device. The sample at each of the stages may be clipped to produce a clipped version of the sample for that stage. The clipped version of the sample for each of the stages may be upsampled to produce an upsampled and clipped version of the sample for that stage. The upsampled and clipped version of the sample for each of the stages may be processed with a filter implementing a combination of crest factor reduction filtering and interpolation filtering of the upsampled and clipped version of the sample for that stage.

### CROSS REFERENCES

The present Application for Patent claims priority to U.S. Provisional Patent Application No. 61/784,426 by Gubeskys et al., entitled “Combined Multi-Stage Crest Factor Reduction and Interpolation of a Signal,” filed Mar. 14, 2013, and U.S. Provisional Patent Application No. 61/809,743 by Gubeskys et al., entitled “Combined Multi-Stage Crest Factor Reduction and Interpolation of a Signal,” filed Apr. 8, 2013, both of which are assigned to the assignee hereof and are expressly incorporated by reference herein.

### BACKGROUND

The present description relates generally to wireless communication, and more specifically to methods, systems, and apparatuses to perform crest factor reduction and interpolation on a signal to be transmitted on a wireless channel. Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communication system may include a number of base stations, each simultaneously supporting communication for multiple mobile devices. Base stations may communicate with mobile devices on downstream and upstream links (i.e., wireless channels and uplink channels). Each base station has a coverage range, which may be referred to as the coverage area of the cell. The base stations and mobile devices may be collectively referred to as wireless devices.

The signals transmitted by wireless devices over wireless channels may suffer from high peak-to-average power ratio (PAPR, also known as crest factor). High PAPR may cause a radio frequency (RF) power amplifier to operate at a lower power efficiency, and thus consume higher quantities of power. This is particularly common in OFDM communication systems.

### SUMMARY

The present description generally relates to one or more improved methods, systems, and/or apparatuses for performing combined crest factor reduction and interpolation on a signal to be transmitted on a wireless channel.

In accordance with a first set of illustrative embodiments, a disclosed method of performing combined crest factor reduction and interpolation on a signal to be transmitted on a wireless channel may include receiving, at each stage of a plurality of cascaded stages in a transmitter of a wireless device, a sample based on a signal to be transmitted on a wireless channel. The sample at each of the stages may be clipped to produce a clipped version of the sample for that stage. The clipped version of the sample for each of the stages may be upsampled to produce an upsampled and clipped version of the sample for that stage. The upsampled and clipped version of the sample for each of the stages may be processed with a filter implementing a combination of crest factor reduction filtering and interpolation filtering of the upsampled and clipped version of the sample for that stage.

In certain examples, a first filtering function may be determined for each of the stages, and the first filtering function may be configured to perform the crest factor reduction filtering of the upsampled and clipped version of the sample for that stage. A set of taps may be determined for the filter at each of the stages based at least in part on the first filtering function for that stage. Additionally, a second filtering function may be determined for each of the stages, and the second filtering function may be configured to perform the interpolation filtering of the upsampled and clipped version of the sample for that stage. The set of taps for the filter at each of the stages may be further determined based at least in part on the second filtering function for that stage. In certain examples, the set of taps for the filter for at least two of the stages are different.

In certain examples, a parameter of the signal to be transmitted on the wireless channel may be identified, and the set of taps for the filter of one of the stages may be modified based at least in part on the parameter of the signal to be transmitted on the wireless channel. For example, the parameter may include a bandwidth of the wireless channel, and a change in bandwidth at the wireless device may be identified. The first filtering function and the second filtering function for the one of the stages may be modified based on the change in bandwidth, and the set of taps for the filter of the one of the stages may be modified based on the modifying the first filtering function and the second filtering function for the one of the stages.

In additional or alternative examples, the parameter may include a radio access technology (RAT) associated with the wireless channel, and a change in the RAT at the wireless device may be identified. The first filtering function and the second filtering function for the one of the stages may be modified based on the change in RAT, and the set of taps for the filter of the one of the stages may be modified based on the modifying the first filtering function and the second filtering function for the one of the stages.

In additional or alternative examples, the parameter may include an out-of-band (OOB) emission requirement associated with the wireless channel, and a change in the OOB emission requirement may be identified at the wireless device. The first filtering function and the second filtering function for the one of the stages may be modified based on the change in OOB emission requirement, and the set of taps for the filter of the one of the stages may be modified based on the modifying the first filtering function and the second filtering function for the one of the stages.

In additional or alternative examples, the parameter may include an error vector magnitude (EVM) associated with the wireless channel, and a change in the EVM may be identified at the wireless device. The first filtering function and the second filtering function for the one of the stages may be modified based on the change in EVM, and the set of taps for the filter of the one of the stages may be modified based on the modifying the first filtering function and the second filtering function for the one of the stages.

In certain examples, an output of the filter for each of the stages comprises a lower peak-to-average power ratio (PAPR) than the sample received at that stage.

In certain examples, a clipping amplitude may be determined for each of the stages, and the clipping the sample for each of the stages may be based on the clipping amplitude for that stage. Clipping the sample at each of the stages may include computing a Look Up Table (LUT) input for each of the stages based on a difference between a squared absolute value of the sample received at that stage and a square of the clipping amplitude for that stage. The LUT input computed for each of the stages may be provided to a LUT of that stage, and the clipped version of the sample received at each of the stages may be computed based on an output of the LUT of that stage and the sample received at that stage.

In certain examples, the combined crest factor reduction and interpolation filtering of the sample may be performed at a digital front end of the transmitter of the wireless device.

In certain examples, the clipping may include polar clipping. In certain examples, the clipping may include one or more of: hard clipping, soft clipping, or peak smoothing.

According to a second set of illustrative embodiments, a wireless modem for performing combined crest factor reduction and interpolation on a signal to be transmitted on a wireless channel may include a plurality of cascaded stages, each of the stages configured to receive a sample based on a signal to be transmitted on a wireless channel. Each stage may include a clipper configured to clip the sample to produce a clipped version of the sample for that stage and an upsampler configured to upsample the clipped version of the sample to produce an upsampled and clipped version of the sample for that stage. Each stage may further include a filter configured to perform a combined crest factor reduction filtering and interpolation filtering on the upsampled and clipped version of the sample for that stage.

In certain examples, the wireless modem may include a crest factor reduction updating module configured to determine a first filtering function for each of the stages, the first filtering function configured to perform the crest factor reduction filtering of the upsampled and clipped version of the sample for that stage. The crest factor reduction updating module may be further configured to determine a set of taps for the filter at each of the stages based at least in part on the first filtering function for that stage.

In certain examples, the crest factor reduction updating module may be further configured to determine a second filtering function for each of the stages, the second filtering function configured to perform the interpolation filtering of the upsampled and clipped version of the sample for that stage; and further determine the set of taps for the filter at each of the stages based at least in part on the second filtering function for that stage.

In certain examples, the set of taps for the filter for at least two of the stages may be different. In certain examples, the crest factor reduction updating module may be further configured to identify a parameter of the signal to be transmitted on the wireless channel, and modify the set of taps for the filter of one of the stages based at least in part on the parameter of the signal to be transmitted on the wireless channel.

In certain examples, an output of the filter for each of the stages may a lower peak-to-average power ratio (PAPR) than the sample received at that stage.

According to a third set of illustrative embodiments, an apparatus for performing combined crest factor reduction and interpolation on a signal to be transmitted on a wireless channel may include means for receiving, at each stage of a plurality of cascaded stages in a transmitter of a wireless device, a sample based on a signal to be transmitted on a wireless channel; means for clipping the sample at each of the stages to produce a clipped version of the sample for that stage; means for upsampling the clipped version of the sample for each of the stages to produce an upsampled and clipped version of the sample for that stage; and means for processing the upsampled and clipped version of the sample for each of the stages with a filter implementing a combination of crest factor reduction filtering and interpolation filtering of the upsampled and clipped version of the sample for that stage.

In certain examples, the apparatus may include means for determining a first filtering function may be determined for each of the stages, where the first filtering function is configured to perform the crest factor reduction filtering of the upsampled and clipped version of the sample for that stage. The apparatus may further include means for determining a set of taps for the filter at each of the stages based at least in part on the first filtering function for that stage. The apparatus may further include means for determining, for each of the stages, a second filtering function configured to perform the interpolation filtering of the upsampled and clipped version of the sample for that stage. The set of taps for the filter at each of the stages may be further determined based at least in part on the second filtering function for that stage. In certain examples, the set of taps for the filter for at least two of the stages may be different.

In certain examples, the apparatus may further include means for identifying a parameter of the signal to be transmitted on the wireless channel, and means for modifying the set of taps for the filter of one of the stages based at least in part on the parameter of the signal to be transmitted on the wireless channel. For example, the parameter may include a bandwidth of the wireless channel, and the apparatus may include means for identifying a change in bandwidth at the wireless device. The apparatus may further include means for modifying the first filtering function and the second filtering function based on the change in bandwidth, and means for modifying the set of taps for the filter of the one of the stages based on the modifying the first filtering function and the second filtering function for the one of the stages.

In additional or alternative examples, the parameter may include a radio access technology (RAT) associated with the wireless channel, and the apparatus may include means for identifying a change in the RAT at the wireless device. The apparatus may further include means for modifying the first filtering function and the second filtering function for the one of the stages based on the change in RAT, and means for modifying the set of taps for the filter of the one of the stages based on the modifying the first filtering function and the second filtering function for the one of the stages.

In additional or alternative examples, the parameter may include an out-of-band (OOB) emission requirement associated with the wireless channel, and the apparatus may include means for identifying a change in the OOB emission requirement at the wireless device. The apparatus may further include means for modifying the first filtering function and the second filtering function for the one of the stages based on the change in OOB emission requirement, and means for modifying the set of taps for the filter of the one of the stages based on the modifying the first filtering function and the second filtering function for the one of the stages.

In additional or alternative examples, the parameter may include an error vector magnitude (EVM) associated with the wireless channel, and the apparatus may include means for identifying a change in the EVM may be identified at the wireless device. The apparatus may also include means for modifying the first filtering function and the second filtering function for the one of the stages based on the change in EVM, and means for modifying the set of taps for the filter of the one of the stages based on the modifying the first filtering function and the second filtering function for the one of the stages.

In certain examples, an output of the filter for each of the stages comprises a lower peak-to-average power ratio (PAPR) than the sample received at that stage.

In certain examples, the apparatus may include means for determining a clipping amplitude for each of the stages, and the clipping the sample for each of the stages may be based on the clipping amplitude for that stage. The means for clipping the sample at each of the stages may include means for computing a Look Up Table (LUT) input for each of the stages based on a difference between a squared absolute value of the sample received at that stage and a square of the clipping amplitude for that stage. The apparatus may further include means for providing the LUT input computed for each of the stages to a LUT of that stage, and means for computing the clipped version of the sample received at each of the stages based on an output of the LUT of that stage and the sample received at that stage.

In certain examples, the apparatus may include means for performing the combined crest factor reduction and interpolation filtering of the sample at a digital front end of the transmitter of the wireless device.

In certain examples, the clipping may include polar clipping. In certain examples, the clipping may include one or more of: hard clipping, soft clipping, or peak smoothing.

According to a fourth set of illustrative embodiments, a non-transitory computer-readable medium may store instructions executable by a processor to: receive, at each stage of a plurality of cascaded stages in a transmitter of a wireless device, a sample based on a signal to be transmitted on a wireless channel; clip the sample at each of the stages to produce a clipped version of the sample for that stage; upsample the clipped version of the sample for each of the stages to produce an upsampled and clipped version of the sample for that stage; and process the upsampled and clipped version of the sample for each of the stages with a filter implementing a combination of crest factor reduction filtering and interpolation filtering of the upsampled and clipped version of the sample for that stage.

In certain examples, the instructions may be further executable by the processor to determine a first filtering function for each of the stages, the first filtering function configured to perform the crest factor reduction filtering of the upsampled and clipped version of the sample for that stage; and determine a set of taps for the filter at each of the stages based at least in part on the first filtering function for that stage.

In certain examples, the instructions may be further executable by the processor to determine a second filtering function for each of the stages, such that the second filtering function may be configured to perform the interpolation filtering of the upsampled and clipped version of the sample for that stage. The set of taps for the filter at each of the stages may be further determined based at least in part on the second filtering function for that stage.

In certain examples, the instructions may be further executable by the processor to identify a parameter of the signal to be transmitted on the wireless channel; and modify the set of taps for the filter of one of the stages based at least in part on the parameter of the signal to be transmitted on the wireless channel.

In certain examples, an output of the filter for each of the stages comprises a lower peak-to-average power ratio (PAPR) than the sample received at that stage.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an isometric view diagram of a wireless communication system;

FIG. 2 is a block diagram illustrating one example of a wireless device in accordance with various embodiments;

FIG. 3 is a block diagram illustrating an example of a complex, multi-stage CFR and interpolation module for performing combined crest factor reduction and interpolation on a signal to be transmitted on a wireless channel, in accordance with various embodiments;

FIG. 4A is a block diagram illustrating one example of a stage of a complex, multi-stage CFR and interpolation module for performing combined crest factor reduction and interpolation on a signal to be transmitted on a wireless channel, in accordance with various embodiments;

FIG. 4B is a block diagram illustrating another example of a stage of a complex, multi-stage CFR and interpolation module for performing combined crest factor reduction and interpolation on a signal to be transmitted on a wireless channel, in accordance with various embodiments;

FIG. 5 is a block diagram illustrating an example of a transmit path of a wireless device in accordance with various embodiments;

FIG. 6 is a block diagram illustrating another example of a transmit path of a wireless device in accordance with various embodiments;

FIG. 7 is a block diagram of a MIMO communication system including a base station and a mobile device;

FIG. 8 is a flow chart illustrating an example of a method of performing combined crest factor reduction and interpolation on a signal to be transmitted on a wireless channel;

FIG. 9 is a flow chart illustrating another example of a method of performing combined crest factor reduction and interpolation on a signal to be transmitted on a wireless channel;

FIG. 10 is a flow chart illustrating yet another example of a method of performing combined crest factor reduction and interpolation on a signal to be transmitted on a wireless channel; and

FIG. 11 is a flow chart illustrating another example of a method of performing combined crest factor reduction and interpolation on a signal to be transmitted on a wireless channel.

### DETAILED DESCRIPTION

As noted in the Background, the signals transmitted by wireless devices over wireless channels may suffer from high PAPR (i.e., high crest factor). High PAPR may cause an RF power amplifier to operate at a lower power efficiency, and thus consume higher quantities of power. This is particularly common in OFDM communication systems.

Various solutions for crest factor reduction (CFR) exist, the most popular of which may be ones based on successive clipping and filtering of a signal to be transmitted. These solutions typically upsample and interpolate the signal to a higher sampling frequency (e.g., to an “oversampling” frequency beyond the Nyquist sampling rate), and then utilize a number of cascaded stages to iteratively 1) clip signals peaks, and 2) filter the clipped signal to remove out-of-band distortion introduced by clipping.

In the methods, systems, and apparatuses described here, CFR functionality may be combined and integrated with interpolation circuitry used for oversampling. More particularly, the low pass filters used by a multi-stage interpolator may be modified to both 1) suppress the digital signal image that appears after a signal is upsampled, and 2) filter out-of-band noise that appears after a clipping operation. The present specification discloses multi-stage interpolators with modified low-pass filters at each stage that act as complex filters to perform both interpolation and CFR filtering. The complex filters may effectively remove out-of-band emission after clipping to reduce PAPR while performing interpolation at the same time. The complex filters may include CFR filters, out-of-band (OOB) filters, masking filters, or shaping filters. Thus, where the low-pass filters at each stage of a typical interpolator circuit may be concerned only with reconstructing the signal operated on by the interpolator at a higher sampling rate, the modified low-pass filters of the present description produce upsampled approximations of the signals, with lower PAPR and minimal distortion both in-band and out-of-band.

As used in the present description and the appended claims, the term CFR filtering refers to filtering applied to a sample to remove out-of-band (OOB) emissions from the sample following clipping to reduce the PAPR of the sample. CFR filtering may include OOB filters, masking filters, shaping filters, and/or other filters that remove OOB emissions. In a multi-stage CFR operation, CFR filtering may be performed at one, some, or each of the stages.

The techniques described herein may be used for various wireless communication systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Referring first to FIG. 1, a diagram illustrates an example of a wireless communications system 100. The wireless communications system 100 includes a plurality of wireless devices, including base stations (or cells) 105 and mobile devices 115. The wireless communications system 100 also includes a core network 130. The base stations 105 may communicate with the mobile devices 115 under the control of a base station controller, which may be part of the core network 130 or the base stations 105 in various embodiments. Base stations 105 may communicate control information and/or user data with the core network 130 through backhaul links 132. In some embodiments, the base stations 105 may communicate, either directly or indirectly, with each other over backhaul links 134, which may be wired or wireless communication links. The wireless communications system 100 may support operation on multiple carriers (waveform signals of different frequencies). Multi-carrier transmitters may transmit modulated signals simultaneously on the multiple carriers. For example, each communication link 125 may be a multi-carrier signal modulated according to various radio technologies. Each modulated signal may be sent on a different carrier and may carry control information (e.g., reference signals, control channels, etc.), overhead information, data, etc.

The base stations 105 may wirelessly communicate with the mobile devices 115 via one or more base station antennas. Each of the base station 105 sites may provide communication coverage for a respective geographic coverage area 110. In some embodiments, a base station 105 may be referred to as a base transceiver station, a radio base station, an access point, a radio transceiver, a basic service set (BSS), an extended service set (ESS), a NodeB, an evolved NodeB (eNodeB or eNB), a Home NodeB, a Home eNodeB, or some other suitable terminology. The geographic coverage area 110 for a base station may be divided into sectors making up only a portion of the coverage area. The wireless communications system 100 may include base stations 105 of different types (e.g., macro, micro, and/or pico base stations). There may be overlapping coverage areas for different technologies.

In some embodiments, the wireless communications system 100 may be an LTE/LTE-A network. In LTE/LTE-A networks, the terms evolved Node B (eNB) and user equipment (UE) may be generally used to describe the base stations 105 and mobile devices 115, respectively. The wireless communications system 100 may be a Heterogeneous LTE/LTE-A network in which different types of eNBs provide coverage for various geographical regions. For example, each eNB may provide communication coverage for a macro cell, a pico cell, a femto cell, and/or other types of cell. A macro cell may generally cover a relatively large geographic area (e.g., several kilometers in radius) and may allow unrestricted access by UEs with service subscriptions with the network provider. A pico cell may generally cover a relatively smaller geographic area and may allow unrestricted access by UEs with service subscriptions with the network provider. A femto cell may also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the base stations 105 via a backhaul link 132. The base stations 105 may also communicate with one another, e.g., directly or indirectly via backhaul links 134 and/or via backhaul links 132 (e.g., through core network 130). The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The mobile devices 115 may be dispersed throughout the wireless communications system 100. One or more of the mobile devices 115 may also be referred to by those skilled in the art as a UE, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A mobile device 115 may include, for example, a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communication links 125 shown in the wireless communications system 100 may include uplink transmissions from a mobile device 115 to a base station 105, and/or downlink transmissions, from a base station 105 to a mobile device 115. The downlink transmissions may also be called forward link transmissions while the uplink transmissions may also be called reverse link transmissions.

Each of the communication links 125 between a base station 105 and a mobile device 115, and each of the backhaul links 134 between base stations 105, may be implemented over a number of wireless channels. Under some conditions, the signals transmitted over the wireless channels may tend to suffer from high PAPR (i.e., high crest factor). High crest factor is particularly common when the signals transmitted over the wireless channels are OFDM signals. To reduce the crest factor of transmitted signals, a transmitter of a wireless device (e.g., a transmitter of a base station 105 or mobile device 115) may include crest factor reduction technology. In the past, crest factor reduction (CFR) technology may have been implemented by means of a multi-stage circuit, where each stage includes a clipping circuit and a stand-alone complex filter providing the crest factor reduction. However, as described herein, multi-stage CFR may be combined with multi-stage interpolation such that each stage of a combined CFR and interpolation circuit may include a single complex filter that performs both interpolation filtering and CFR filtering. In some cases, a combined CFR and interpolation filter may be implemented, for example, with fewer components, at a lower cost, and/or with better performance than with separate interpolation and CFR filters (e.g., faster processing, and comparable or better PAPR).

A combined CFR and interpolation filter may be incorporated into any of the wireless or wired transmitters employed by base stations 105 or mobile devices 115 in the wireless communications system 100.

While the wireless communications system 100 is principally described in relation to LTE/LTE-A architectures, those skilled in the art will readily appreciate that the various concepts presented throughout this disclosure may be extended to other types of wireless networks.

FIG. 2 is a block diagram 200 illustrating one embodiment of a wireless device 201 in accordance with the present systems and methods. The wireless device 201 may be an example of one of the base stations 105 or mobile devices 115 illustrated in FIG. 1. The wireless device 201 may include a receiver module 205, a modem 210, and a transmitter module 215. Each of these components may be in communication with each other, directly or indirectly.

The components of the wireless device 201 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In some configurations, the receiver module 205 may include a cellular or other type of wireless receiver (e.g., an LTE/LTE-A receiver) and may receive transmissions from one or more other wireless devices. The transmissions may include various types of traffic data, control signals, and/or other transmissions. The transmissions may be received over a number of wireless channels, such as a number of wireless channels of a downlink or uplink of one of the communication links 125 shown in FIG. 1.

The transmitter module 215 may also include a cellular or other type of wireless transmitter (e.g., an LTE/LTE-A transmitter) and may transmit various types of traffic data, control signals, and/or other transmissions to one or more other wireless devices. The transmissions may be sent over a number of wireless channels, such as a number of wireless channels of a downlink or uplink of one of the communication links 125 shown in FIG. 1. In some embodiments, the modem 210 may prepare the traffic data, control signals, and/or other transmissions that are to be transmitted on a wireless channel or channels via the transmitter module 215.

The modem 210 may in some cases include a multi-stage CFR and interpolation module 220. The multi-stage CFR and interpolation module 220 may include a plurality of cascaded stages. Each of the stages may be configured to receive at least one complex sample based on a signal to be transmitted on a wireless channel (e.g., via the transmitter module 215). The at least one complex sample at each of the stages may be clipped to produce a clipped version of the at least one complex sample for that stage. The clipped version of the at least one complex sample for each of the stages may then be upsampled to produce an upsampled and clipped version of the at least one complex sample for that stage. The upsampled and clipped version of the at least one complex sample for each of the stages may then be processed with a complex filter implementing a combination of crest factor reduction filtering and interpolation filtering of the upsampled and clipped version of the at least one complex sample for that stage.

In contrast to past systems and methods where interpolation was performed separately from crest factor reduction, using separate multi-stage interpolation circuits employing interpolation filters and separate multi-stage CFR circuits employing CFR filters, the multi-stage CFR and interpolation module 220 combines interpolation filtering with crest factor reduction filtering and performs both types of filtering at each of a plurality of cascaded combined CFR and interpolation stages.

This may, in some embodiments, provide interpolation filtering and crest factor reduction filtering with fewer components, at a lower cost, and/or with better performance than with separate interpolation and CFR filters.

FIG. 3 shows a more detailed example of a multi-stage CFR and interpolation module 220-a. The multi-stage CFR and interpolation module 220-a may be an example of the multi-stage CFR and interpolation module 220 shown in FIG. 2. The interpolation module 220-a may include a first cascaded stage 305-a and a second cascaded stage 305-b. Each of the cascaded stages 305-a, 305-b may in turn include a clipper 310-a, 310-b, an upsampler 315-a, 315-b, and/or a complex filter 320-a, 320-b. Each of these components may be in communication with each other, directly or indirectly.

The clipper 310-a, 310-b at each of the cascaded stages 305-a, 305-b may be configured to clip the at least one complex sample at that stage, to produce a clipped version of the at least one complex sample for that stage. The clipping may in some cases include polar clipping, hard clipping, soft clipping, and/or peak smoothing. The clippers 310-a, 310-b may perform their clipping using the same or different clipping methods or functions.

The upsampler 315-a, 315-b at each of the stages 305-a, 305-b may be configured to upsample the clipped version of the at least one complex sample at that stage, to produce an upsampled and clipped version of the at least one complex sample for that stage. The upsamplers 315-a, 315-b may perform their upsampling using the same or different upsampling methods or functions. In some embodiments, the upsamplers 315-a, 315-b may upsample by the same factor. In other embodiments, the upsamplers 315-a, 315-b may upsample by different factors. The upsampling factors for the upsamplers 315-a, 315-b are labeled M and N, respectively. M and N may be equal or not equal.

The complex filter 320-a, 320-b at each of the cascaded stages 305-a, 305-b may be configured to perform a combined crest factor reduction filtering and interpolation filtering on the upsampled and clipped version of the at least one complex sample at that stage. The complex filters 320-a, 320-b may in some cases be finite impulse response (FIR) filters. The complex filters 320-a, 320-b may perform their filtering using the same or different filtering methods or functions.

In some embodiments, a first filtering function may be determined for each of the cascaded stages 305-a, 305-b. The first filtering function may be configured to perform crest factor reduction filtering of the upsampled and clipped version of the at least one complex sample for that stage. A second filtering function may also be determined for each of the cascaded stages 305-a, 305-b. The second filtering function may be configured to perform the interpolation filtering of the upsampled and clipped version of the at least one complex sample for that stage. A set of complex taps may be determined for the complex filter 320-a, 320-b at each of the stages 305-a, 305-b based at least in part on the first filtering function for that stage. The set of complex taps may also be determined based at least in part on the second filtering function for that stage. In certain examples, a preliminary set of complex taps may be determined for the first filtering function for that stage 305, and a final set of complex taps may be determined for the complex filter 320-a, 320-b of that stage 305 by modifying the preliminary set of complex taps based on the second filtering function. The set of complex taps for different complex filters 320-a, 320-b may be the same or different.

In some designs, one goal of the complex filters 320-a, 320-b may be to suppress the digital signal image formed by upsampling. Another goal may be to reduce the out-of-band (OOB) signal distortion introduced by clipping. With these goals in mind, the frequency response of the complex filter 320-a of the first stage 305-a may be that of a low-pass filter (LPF) having a sharp transition band at the channel (signal band) edge. However, the response of the complex filter 320-a of the first stage 305-a near the filter's stopband may be less important, because the complex filter 320-b of the second stage 305-b may be available to attenuate the signal at higher frequencies. In fact, the availability of the complex filter 320-b of the second stage 305-b to attenuate high frequencies may be exploited to reduce the total filter length (i.e., the combined length of the complex filters 320-a, 320-b of the first and second stages 305-a, 305-b). In some embodiments, the exact cut-off frequencies and band attenuations of the complex filters 320-a, 320-b may be designed to achieve optimal trade-offs between PAPR, (Adjacent Channel Leakage power Ratio) ACLR, and error vector magnitude (EVM). In some embodiments, each of the complex filters 320-a, 320-b may be configured as an equirriple FIR filter, designed using the Parks-McLellan algorithm.

By way of example, FIG. 3 shows a multi-stage CFR and interpolation module 220-a having two cascaded stages 305-a, 305-b. In other embodiments, a multi-stage CFR and interpolation module could have any number of two or more stages. In some embodiments, an output of the complex filter 320-a, 320-b for each of the cascaded stages 305-a, 305-b has a lower PAPR than the at least one complex sample received at that stage.

By way of example and not limitation, a two-stage CFR and interpolation module 220-a may be designed for LTE transmissions having a 20 MHz bandwidth. According to this use case, the CFR and interpolation module 220-a may be configured to have a maximum EVM of about −22 dB (8%), a maximum ACLR of about −45 dB, a maximum alternate ACLR of less than about −50 dB, and a minimum spectral mask attenuation of about −33 dB at 0.1 MHz beyond the band edge (e.g., −33 dB at 10.1 MHz for a 20 MHz bandwidth). Accordingly, the design of the complex filters 320-a, 320-b in each stage 305-a, 305-b may be based on the goal of reducing PAPR while maintaining the performance specifications given above.

Continuing with the example of multi-stage combined CFR and interpolation in an LTE system, the design constraints of the complex filter 320-a of the first stage may be less demanding in the higher frequencies region, as the complex filter 320-b of the second stage may handle attenuation for these frequencies. Therefore, by reducing the demands on the complex filter 320-a of the first stage 305-a in the higher frequencies, the overall complexity and length of the complex filter 320-a of the first stage 305-a may be reduced. Based at least in part on the cost associated with achieving sharp transition bands at higher sampling rates, the principal design consideration for the complex filter 320-a of the first stage 305-a may be to bring the signal into compliance with spectral mask requirements. Thus, the complex filter 320-a of the first stage 305-a may be chosen to attenuate distortion at 0.1 MHz beyond the band edge (at 10.1 MHz for a 20 MHz bandwidth) to less than −33 dB.

In certain examples, the Parks-McClellan algorithm may be used to design an equirriple finite impulse response (FIR) filter for the complex filter 320-a of the first stage 305-a. For example, for an LTE transmission of 20 MHz the Parks-McClellan algorithm may be used to select a set of complex taps for a FIR filter having between 1 and 3% passband ripple and a transition band from 9 MHz to 10.1 MHz reaching between −33 dB and −37 dB at 10.1 MHz. In one specific example, the complex filter 320-a of the first stage 305-a may be a FIR filter with 55-70 taps that has a 2% passband ripple and a transition band from 9 MHz to 10.1 MHz reaching less than −33 dB at 10.1 MHz.

Continuing with the example of multi-stage combined crest factor reduction and interpolation in an LTE system, the complex filter 320-b of the second stage 305-b may be designed by first determining an impulse response of the complex filter 320-b of the second stage 305-b. For a bandwidth of 20 MHz, the impulse response may have a frequency response of 0 dB from around 0 to around 9 MHz, a steep transition to less than −33 dB from around 9 MHz to around 10.1 MHz, remain below −30 dB from around 20 MHz to around 50 MHz, and remain below −55 dB for frequencies greater than around 50 MHz. In a more specific example, the frequency response of the impulse response may remain at 0 dB from 0 to 9.015 MHz, transition from 0 dB to −35 dB between 9.015 and 10.1 MHz, remain below −30 dB from 20-50 MHz, and remain below −55 dB for frequencies greater than 50 MHz. The impulse response may be then weighted with a tapering window, and truncated to a reasonable length. Cut-off frequencies and band attenuation may then be tuned to achieve an appropriate balance between PAPR, ACLR, and EVM. A set of taps may then be computed based on the weighted, truncated, and tuned impulse response. In one set of examples, the complex filter 320-b of the second stage 305-b may have a length in the range of 90-110 taps.

Continuing with the example of multi-stage combined crest factor reduction and interpolation in an LTE system, using the illustrative designs given above for the complex filters 320-a, 320-b, PAPR clipping levels of around 4.7 dB for the clipper 310-a of the first stage and around 4.5 dB for the clipper 310-b of the second stage 305-b may be set. With these clipping values and the filter designs described above, the multi-stage CFR and interpolation module 220-a may obtain an overall 6.5 dB reduction in PAPR while maintaining an EVM of −26 dB, an ACLR of −58 dB, and alternate ACLR of −60 dB, in compliance with the LTE standard.

It will be understood that while the foregoing example has been given with respect to performing multi-stage combined CFR and interpolation in an LTE system for a bandwidth of 10 MHz, the principles of the present specification may apply generally to other types of wireless transmissions with other PAPR, EVM, ACLR, and spectral mask constraints. Accordingly, the filtering and clipping parameters of the multi-stage CFR and interpolation module 220-a may vary based on these differences in design constraints.

FIG. 4A shows a more detailed example of a single stage 305-c of a multi-stage CFR and interpolation module. The stage 305-c may be an example of one stage of the multi-stage CFR and interpolation module 220 shown in FIG. 2 or 3. The stage 305-c may include a clipper 310-c, an upsampler 315-c, and/or a complex filter 320-c. Each of these components may be in communication with each other, directly or indirectly.

By way of example, the clipper 310-c is shown to be one example of a hard polar clipper. In additional or alternative examples, other types of hard or soft, polar or non-polar clippers may be used. Input samples above a specified saturation level (or clipping amplitude A) are simply saturated to that level. The clipping amplitude A may be determined separately for each stage, depending on the characteristics of the signal. In the embodiment shown, the clipper 310-c receives at least one complex sample s(n) at a squaring module 405 and a delay module 420, and performs clipping based on the clipping amplitude A for the stage 305-c. More specifically, the squaring module 405 may find the squared absolute value of the at least one complex sample. The summer 410 may then compute a Look Up Table (LUT) input as the difference between the squared absolute value of the at least one complex sample and a square of the clipping amplitude A. The LUT 415 may then receive the LUT input and output a clipping factor, which clipping factor may be converted to a clipping percentage by the summer 425. The combiner/multiplier 430 may then compute the clipped version s_{c}(n) of the at least one complex sample, based on the output of the LUT and the at least one complex sample. More specifically, the combiner/multiplier 430 may multiply a delayed version of the at least one complex sample (delayed by the delay module 420) by the clipping percentage.

The upsampler 315-c may be configured to upsample the clipped version of the at least one complex sample received from the clipper 310-c, to produce an upsampled and clipped version of the at least one complex sample.

The complex filter 320-c may be configured to perform a combined crest factor reduction filtering and interpolation filtering on the upsampled and clipped version of the at least one complex sample received from the upsampler 315-c. The complex filter 320-c may in some cases be a FIR filter. The complex filter 320-c may include a combined number of complex CFR and interpolator taps. The complex taps may in some cases be modified. For example, the complex taps may in some cases be modified based at least in part on at least one parameter of a signal to be transmitted on the wireless channel to which the stage 305-c pertains.

FIG. 4B shows another more detailed example of a single stage 305-d of a multi-stage CFR and interpolation module. The stage 305-d may be another example of one stage of the multi-stage CFR and interpolation module 220 shown in FIG. 2 or 3. The stage 305-d may include a clipper 310-d, an upsampler 315-d, and/or a complex filter 320-d. Each of these components may be in communication with each other, directly or indirectly.

By way of example, the clipper 310-d is shown to be a soft polar clipper (or polar compander). In the embodiment shown, the clipper 310-c receives at least one complex sample s(n) at a squaring modules 405-a and a delay module 420-a, and performs clipping based on the clipping amplitude A for the stage 305-d. More specifically, the squaring module 405-a may find the squared absolute value of the at least one complex sample. The summer 410-a may then compute a LUT input as the difference between the squared absolute value of the at least one complex sample and a square of the clipping amplitude A. The LUT 415-a may then receive the LUT input and output a clipping factor, which clipping factor may be converted to a clipping percentage by the summer 425-a. However, prior to conversion of the clipping factor to the clipping percentage, the clipping factor may be processed by a soft-clipping FIR 435. The combiner/multiplier 430-a may compute the clipped version sₑ(n) of the at least one complex sample, based on the output of the LUT and the at least one complex sample. More specifically, the combiner/multiplier 430-a may multiply a delayed version of the at least one complex sample (delayed by the delay modules 420-a and 420-b) by the clipping percentage.

The upsampler 315-d may be configured to upsample the clipped version of the at least one complex sample received from the clipper 310-d, to produce an upsampled and clipped version of the at least one complex sample.

The complex filter 320-d may be configured to perform a combined crest factor reduction filtering and interpolation filtering on the upsampled and clipped version of the at least one complex sample received from the upsampler 315-d. The complex filter 320-d may in some cases be a FIR filter. The complex filter 320-d may include a combined number of complex CFR and interpolator taps. The complex taps may in some cases be modified. For example, the complex taps may in some cases be modified based at least in part on at least one parameter of a signal to be transmitted on the wireless channel to which the stage 305-d pertains.

FIG. 5 is a block diagram 500 illustrating one embodiment of a transmit path of a wireless device 201-a. The wireless device 201-a may be an example of the wireless device 201 described in FIG. 2. In one example, the wireless device 201-a may include a baseband modulator 505, a digital front end (DFE) module 510, a radio frequency (RF) module 515, a power amplifier (PA) 520, and an antenna 525. Each of these components may be in communication with each other, directly or indirectly.

In one configuration, the baseband modulator 505 may modulate a baseband signal and the in-phase (I) and quadrature (Q) components of the modulated signal (or complex samples based on the modulated signal) may be passed to the DFE module 510. In some embodiments, the baseband modulator 505 may be part of the DFE module 510. The DFE module 510 may perform various digital signal processing (DSP) techniques on the complex samples based on the modulated baseband signal. The complex samples may then be converted to an analog signal and passed to the RF module 515. The RF module 515 may filter the analog signal. The power amplifier 520 may amplify the analog signal before the signal is transmitted via an antenna 525.

In some embodiments, the DFE module 510 may include a multi-stage CFR and interpolation module 220-b. The multi-stage CFR and interpolation module 220-b may be an example of the multi-stage CFR and interpolation module 220 illustrated in FIGS. 2 and/or 3. The multi-stage CFR and interpolation module 220-b may include a plurality of cascaded stages, which in some cases may take the forms of stages 305 shown in FIGS. 3, 4A, and/or 4B. Each of the stages may be configured to receive the complex samples based on the modulated baseband signal. The complex samples at each of the stages may be clipped to produce a clipped version of the complex samples for that stage. The clipped version of the complex samples for each of the stages may then be upsampled to produce an upsampled and clipped version of the complex samples for that stage. The upsampled and clipped version of the complex samples for each of the stages may then be processed with a complex filter implementing a combination of crest factor reduction filtering and interpolation filtering of the upsampled and clipped version of the complex samples.

FIG. 6 is a block diagram 600 illustrating a further embodiment of a transmit path of a wireless device 201-b. The wireless device 201-b may be an example of the wireless device 201 described in FIGS. 2 and/or 5. In one example, the wireless device 201-b may include a baseband modulator 505-a, a DFE module 510-a, a digital-to-analog converter (DAC) 645, an RF module 515-a, a power amplifier 520-a, and/or a CFR updating module 610. The DFE module 510-a may include a multi-stage CFR and interpolation module 220-c, a digital pre-distortion module 630, an I/Q imbalance compensation module 635, and/or a transmitter equalizer 640. The RF module 515-a may include analog filters 650 and an I/Q modulator 655. The CFR updating module may include a clipping factor modification module 660 and/or a filter tap modification module 665. Each of these components may be in communication with each other, directly or indirectly.

In one configuration, the baseband modulator 505-a may modulate a baseband signal and the in-phase (I) and quadrature (Q) components of the modulated signal (or complex samples based on the modulated signal) may be passed to the DFE module 510-a. In some embodiments, the baseband modulator 505-a may be part of the DFE module 510-a. The DFE module 510-a may perform various digital signal processing (DSP) techniques on the complex samples, including crest factor reduction and interpolation (e.g., at multi-stage CFR and interpolation module 220-c), digital pre-distortion (e.g., at digital pre-distortion module 630), I/Q imbalance compensation (e.g., at I/Q imbalance compensation module 635, and/or transmitter equalization (e.g., at transmitter equalizer 640). The complex samples may then be converted to an analog signal at the digital-to-analog converter (DAC) 645 and passed to the RF module 515-a. The RF module 515-a may filter the analog signal (e.g., at analog filters 650) and perform I/Q modulation (e.g., at I/Q modulator 655). The power amplifier 520-a may amplify the analog signal before the signal is transmitted to another wireless device.

The multi-stage CFR and interpolation module 220-c may be an example of the multi-stage CFR and interpolation module 220 illustrated in FIGS. 2, 3 and/or 5. The multi-stage CFR and interpolation module 220-c may include a plurality of cascaded stages, which in some cases may take the forms of stages 305 shown in FIGS. 3, 4A, and/or 4B. Each of the stages may be configured to receive the complex samples based on the modulated baseband signal. The complex samples at each of the stages may be clipped to produce a clipped version of the complex samples for that stage. The clipped version of the complex samples for each of the stages may then be upsampled to produce an upsampled and clipped version of the complex samples for that stage. The upsampled and clipped version of the complex samples for each of the stages may then be processed with a complex filter implementing a combination of crest factor reduction filtering and interpolation filtering of the upsampled and clipped version of the complex samples.

The digital pre-distortion module 630, I/Q imbalance compensation module 635, and/or transmitter equalizer 640 may compensate for various impairments that may be introduced by analog and RF components (e.g., DAC 645, analog filters 650, I/Q modulator 655, power amplifier 520-a, etc.), also referred to as the analog pipeline of the wireless device 201-b. These impairments may include mismatches between the gain and phase of I/Q components, local oscillator (LO) leakage, gain variations, and non-linear effects. In some embodiments, the impairments may be subject to thermal and temporal variations.

The clipping factor modification module 660 may be configured to modify one or more of the clipping factors associated with one or more of the combined CFR and interpolation stages of the multi-stage CFR and interpolation module 220-c. In certain examples, different sets of clipping factors may be useful for performing CFR on different types of signals. For example, a signal with a higher PAPR may have a higher clipping factor in the first stages of the multi-stage CFR and interpolation module 220-c than a signal with a lower PAPR. In certain examples, the clipping factor modification module 660 may 1) identify at least one parameter affecting the transmission of the modulated baseband signal on a wireless channel, and 2) determine whether there is any change in the at least one parameter. The parameter may include, for example, the PAPR of the signal, a bandwidth of the wireless channel, a radio access technology (RAT) associated with the wireless channel, an OOB emission requirement associated with the wireless channel, an EVM associated with the wireless channel, or other relevant parameters. If a change in at least one of these parameters occurs, a new set of clipping factors for the clippers of one or more of the stages of the multi-stage CFR and interpolation module 220-c may be selected based on the change.

The filter tap modification module 665 may 1) identify at least one parameter affecting transmission of the modulated baseband signal on a wireless channel, and 2) determine whether there is a change in the at least one parameter. By way of example, the parameter may include a bandwidth of the wireless channel, a radio access technology (RAT) associated with the wireless channel, an OOB emission requirement associated with the wireless channel, and/or an EVM associated with the wireless channel. If there has been no change in the at least one parameter, the filter tap modification module 665 need not modify anything. However, if the at least one parameter has changed, the filter tap modification module 665 may determine a new set of complex taps for the complex filter of at least one stage of the multi-stage CFR and interpolation module 220-c. The new set of complex taps may be determined by modifying a CFR filtering function and/or interpolation filtering function for the at least one of the stages, and then modifying the existing set of complex taps based on the modification(s) to the filtering function(s). The modifications may be based on the identified change in the at least one parameter (e.g., the change in the bandwidth, the RAT, the OOB emission requirement, and/or the EVM). After determining the new set of complex taps, the filter tap modification module 665 may configure the affected filters with the new set of complex taps. The operations performed by the filter tap modification module 665 may be performed at periodic or aperiodic intervals.

FIG. 7 is a block diagram of a wireless communications system 700 including a base station 105-a and a mobile device 115-a. This wireless communications system 700 may illustrate aspects of the wireless communications system 100 of FIG. 1. The base station 105-a and/or the mobile device 115-a may be configured as a wireless device 201, in accord with the teachings of FIGS. 2, 5, and/or 6. The base station 105-a may be equipped with antennas 734-a through 734-x, and the mobile device 115-a may be equipped with antennas 752-a through 752-n. In the wireless communications system 700, the base station 105-a may be able to send data over multiple wireless channels (or communication links) at the same time. Each wireless channel may be called a “layer” and the “rank” of the wireless channel may indicate the number of layers used for communication. For example, in a 2×2 MIMO system where base station 105-a transmits two “layers,” the rank of the communication link between the base station 105-a and mobile device 115-a is two.

At the base station 105-a, a transmit processor 720 may receive data from a data source. The transmit processor 720 may process the data. The transmit processor 720 may also generate reference symbols. A transmit (TX) MIMO processor 730 may perform spatial processing (e.g., precoding) on data symbols, control symbols, and/or reference symbols, if applicable, and may provide output symbol streams to the modulator/demodulators 732-a through 732-x. Each modulator/demodulator 732 may process a respective output symbol stream (e.g., for OFDM, etc.) to obtain an output sample stream. The processing of the output symbol streams may include reducing the crest factor of and interpolating at least one complex sample of each output symbol stream. The crest factor reduction and interpolation may be accomplished in a multi-stage CFR and interpolation module (e.g., at 220-d or 220-e). Each of the multi-stage CFR and interpolation modules 220-d, 220-e may be an example of one of the multi-stage CFR and interpolation modules 220 shown in FIGS. 2, 3, 5, and/or 6. Crest factor reduction and interpolation may be performed for each output symbol stream or wireless channel. Each modulator/demodulator 732 may further process (e.g., convert to analog, amplify, filter, and upconvert) the output sample stream to obtain a downlink (DL) signal. In one example, DL signals from modulator/demodulators 732-a through 732-x may be transmitted via the antennas 734-a through 734-x, respectively.

At the mobile device 115-a, the antennas 752-a through 752-n may receive the DL signals from the base station 105-a and provide the received signals to the modulator/demodulators 754-a through 754-n, respectively. Each modulator/demodulator 754 may condition (e.g., filter, amplify, downconvert, and digitize) a respective received signal to obtain input samples. Each modulator/demodulator 754 may further process the input samples (e.g., for OFDM, etc.) to obtain received symbols. A MIMO detector 756 may obtain received symbols from all the modulator/demodulators 754-a through 754-n, perform MIMO detection on the received symbols if applicable, and provide detected symbols. A receive processor 758 may process (e.g., demodulate, deinterleave, and decode) the detected symbols, providing decoded data for the mobile device 115-a to a data output, and provide decoded control information to a processor 780, or memory 782.

On the uplink (UL), at the mobile device 115-a, a transmit processor 764 may receive and process data from a data source. The transmit processor 764 may also generate reference symbols for a reference signal. The symbols from the transmit processor 764 may be precoded by a transmit MIMO processor 766 if applicable, be further processed by the modulator/demodulators 754-a through 754-n (e.g., for SC-FDMA, etc.), and be transmitted to the base station 105-a in accordance with the transmission parameters received from the base station 105-a. The processing of the output symbol streams may include reducing the crest factor of and interpolating at least one complex sample of each output symbol stream. The crest factor reduction and interpolation may be accomplished in a multi-stage CFR and interpolation module (e.g., at 220-f or 220-g). Each of the multi-stage CFR and interpolation modules 220-f, 220-g may be an example of one of the multi-stage CFR and interpolation modules 220 shown in FIGS. 2, 3, 5, and/or 6. Crest factor reduction and interpolation may be performed for each output symbol stream or wireless channel.

At the base station 105-a, the UL signals from the mobile device 115-a may be received by the antennas 734, processed by the modulator/demodulators 732, detected by a MIMO detector 736 if applicable, and further processed by a receive processor. The receive processor 738 may provide decoded data to a data output and to the processor 740.

The components of the mobile device 115-a may, individually or collectively, be implemented with one or more Application Specific Integrated Circuits (ASICs) adapted to perform some or all of the applicable functions in hardware. Each of the noted modules may be a means for performing one or more functions related to operation of the wireless communications system 700. Similarly, the components of the base station 105-a may, individually or collectively, be implemented with one or more Application Specific Integrated Circuits (ASICs) adapted to perform some or all of the applicable functions in hardware. Each of the noted components may be a means for performing one or more functions related to operation of the wireless communications system 700.

FIG. 8 is a flow chart illustrating an example of a method 800 of performing crest factor reduction and interpolation on a signal to be transmitted on a wireless channel. For clarity, the method 800 is described below with reference to one of the wireless devices 201 shown in FIGS. 2, 5, and/or 6. In some implementations, the multi-stage CFR and interpolation modules 220 described with reference to FIGS. 2, 3, 5, 6, and/or 7 may execute one or more sets of codes to control the functional elements of a wireless device 201 to perform the functions described below.

At block 805, at least one complex sample based on a signal to be transmitted on a wireless channel may be received at each stage of a plurality of cascaded stages in a transmitter of a wireless device 201.

At block 810, the at least one complex sample may be clipped at each of the stages to produce a clipped version of the at least one complex sample for that stage. The clipping may in some cases be performed at the clipper 310 described with reference to FIGS. 3, 4A, and/or 4B. The clipping may in some cases include polar clipping, hard clipping, soft clipping, and/or peak smoothing.

At block 815, the clipped version of the at least one complex sample for each of the stages may be upsampled to produce an upsampled and clipped version of the at least one complex sample for that stage. The upsampling may in some cases be performed at the upsampler 315 described with reference to FIGS. 3, 4A, and/or 4B.

At block 820, the upsampled and clipped version of the at least one complex sample for each of the stages may be processed with a complex filter. The complex filter may implement a combination of crest factor reduction filtering and interpolation filtering of the upsampled and clipped version of the at least one complex sample for that stage. The filtering may in some cases be performed at one or more of the complex filters 320 described with reference to FIGS. 3, 4A, and/or 4B.

Thus, the method 800 may perform crest factor reduction and interpolation on a signal to be transmitted on a wireless channel. It should be noted that the method 800 is just one implementation and that the operations of the method 800 may be rearranged or otherwise modified such that other implementations are possible.

FIG. 9 is a flow chart illustrating an example of a method 900 of performing crest factor reduction and interpolation on a signal to be transmitted on a wireless channel. For clarity, the method 900 is described below with reference to one of the wireless devices 201 shown in FIGS. 2, 5, and/or 6. In some implementations, the multi-stage CFR and interpolation modules 220 described with reference to FIGS. 2, 3, 5, 6, and/or 7 may execute one or more sets of codes to control the functional elements of a wireless device 201 to perform the functions described below.

At block 905, a first filtering function may be determined for each stage of a plurality of cascaded stages in a transmitter of a wireless device 201. The first filtering function for a stage may be configured to perform a crest factor reduction filtering of at least one complex sample received at that stage.

At block 910, a second filtering function may be determined for each of the stages. The second filtering function for a stage may be configured to perform an interpolation filtering of the at least one complex sample received at that stage.

At block 915, a set of complex taps may be determined for a complex filter at each of the stages. The set of complex taps may be determined based at least in part on the first filtering function for that stage, and may also be based on the second filtering function for that stage.

At block 920, a clipping amplitude may be determined for each of the stages.

Each of the operations performed at blocks 905, 910, 915, and/or 920 may in some cases be performed at the CFR updating module 610 described with reference to FIG. 6.

At block 925, at least one complex sample based on a signal to be transmitted on a wireless channel may be received at each of the stages.

At block 930, the at least one complex sample may be clipped at each of the stages to produce a clipped version of the at least one complex sample for that stage. The clipping of the at least one complex sample for each of the stages may be based on the clipping amplitude for that stage. The clipping may in some cases be performed at the clipper 310 described with reference to FIGS. 3, 4A, and/or 4B. The clipping may in some cases include polar clipping, hard clipping, soft clipping, and/or peak smoothing.

At block 935, the clipped version of the at least one complex sample for each of the stages may be upsampled to produce an upsampled and clipped version of the at least one complex sample for that stage. The upsampling may in some cases be performed at the upsampler 315 described with reference to FIGS. 3, 4A, and/or 4B.

At block 940, the upsampled and clipped version of the at least one complex sample for each of the stages may be processed with the complex filter. The complex filter implements a combination of crest factor reduction filtering and interpolation filtering of the upsampled and clipped version of the at least one complex sample for that stage. The filtering may in some cases be performed at one or more of the complex filters 320 described with reference to FIGS. 3, 4A, and/or 4B.

Thus, the method 900 may perform crest factor reduction and interpolation on a signal to be transmitted on a wireless channel. It should be noted that the method 900 is just one implementation and that the operations of the method 900 may be rearranged or otherwise modified such that other implementations are possible.

FIG. 10 is a flow chart illustrating an example of a method 1000 of performing crest factor reduction and interpolation on a signal to be transmitted on a wireless channel. For clarity, the method 1000 is described below with reference to one of the wireless devices 201 shown in FIGS. 2, 5, and/or 6. In some implementations, the multi-stage CFR and interpolation modules 220 described with reference to FIGS. 2, 3, 5, 6, and/or 7 may execute one or more sets of codes to control the functional elements of a wireless device 201 to perform the functions described below.

At block 1005, at least one complex sample based on a signal to be transmitted on a wireless channel may be received at each of a plurality of combined CFR/interpolation stages in a transmitter of a wireless device 201. Each of the combined CFR/interpolation stages may include a complex FIR filter having a set of complex taps. The set of complex taps may be based on a CFR filtering function and an interpolation filtering function.

At block 1010, the at least one complex sample may be clipped at each of the stages to produce a clipped version of the at least one complex sample for that stage. The clipping may in some cases be performed at the clipper 310 described with reference to FIGS. 3, 4A, and/or 4B. The clipping may in some cases include polar clipping, hard clipping, soft clipping, and/or peak smoothing.

At block 1015, the clipped version of the at least one complex sample for each of the stages may be upsampled to produce an upsampled and clipped version of the at least one complex sample for that stage. The upsampling may in some cases be performed at the upsampler 315 described with reference to FIGS. 3, 4A, and/or 4B.

At block 1020, a combined CFR and interpolation filtering of the upsampled and clipped version of the at least one complex sample may be performed at each of the stages using a complex FIR filter. The filtering may in some cases be performed at one or more of the complex filters 320 described with reference to FIGS. 3, 4A, and/or 4B.

At block 1025, at least one parameter affecting the signal to be transmitted on the wireless channel may be identified, and it may be determined whether the at least one parameter has changed (i.e., a change, if any, in the at least one parameter may be identified). By way of example, the parameter may include a bandwidth of the wireless channel, a radio access technology (RAT) associated with the wireless channel, an OOB emission requirement associated with the wireless channel, and/or an EVM associated with the wireless channel. If there has been no change in the at least one parameter, the operations performed at blocks 1005, 1010, 1015, and 1020 may be repeated. However, if the at least one parameter has changed, processing may continue at block 1030. The operations at block 1025 may in some cases be performed at the CFR updating module 610 described with reference to FIG. 6.

At block 1030, a new set of complex taps may be determined for the complex FIR filter of at least one of the stages. The new set of complex taps may be determined by modifying the CFR filtering function and/or the interpolation filtering function for the at least one of the stages, and then modifying the existing set of complex taps based on the modification(s) to the filtering function(s). The modifications may be based on the identified change in the at least one parameter (e.g., the change in the bandwidth, the RAT, the OOB emission requirement, and/or the EVM). The operations at block 1030 may in some cases be performed at the CFR updating module 610 described with reference to FIG. 6.

At block 1035, the complex FIR filter may be configured according to the new set of complex taps. The operations at block 1035 may in some cases be performed at the CFR updating module 610 described with reference to FIG. 6.

Thus, the method 1000 may perform crest factor reduction and interpolation on a signal to be transmitted on a wireless channel. It should be noted that the method 1000 is just one implementation and that the operations of the method 1000 may be rearranged or otherwise modified such that other implementations are possible.

FIG. 11 is a flow chart illustrating an example of a method 1100 of performing crest factor reduction and interpolation on a signal to be transmitted on a wireless channel. For clarity, the method 1100 is described below with reference to one of the wireless devices 201 shown in FIGS. 2, 5, and/or 6. In some implementations, the multi-stage CFR and interpolation modules 220 described with reference to FIGS. 2, 3, 5, 6, and/or 7 may execute one or more sets of codes to control the functional elements of a wireless device 201 to perform the functions described below.

At block 1105, at least one complex sample based on a signal to be transmitted on a wireless channel may be received at each of a plurality of combined CFR/interpolation stages in a transmitter of a wireless device 201. Each of the combined CFR/interpolation stages may include a complex FIR filter having a set of complex taps. The set of complex taps may be based on a CFR filtering function and an interpolation filtering function.

At block 1110, the at least one complex sample may be clipped at a clipper of the stage, to produce a clipped version of the at least one complex sample for that stage. The clipping may in some cases be performed at the clipper 310 described with reference to FIGS. 3, 4A, and/or 4B. The clipping may in some cases include polar clipping, hard clipping, soft clipping, and/or peak smoothing.

At block 1115, the clipped version of the at least one complex sample for each of the stages may be upsampled at an upsampler of the stage, to produce an upsampled and clipped version of the at least one complex sample for that stage. The upsampling may in some cases be performed at the upsampler 315 described with reference to FIGS. 3, 4A, and/or 4B.

At block 1120, a combined CFR and interpolation filtering of the upsampled and clipped version of the at least one complex sample may be performed at each of the stages using a complex FIR filter. The combined CFR and interpolation filtering may in some cases be performed at a multi-stage CFR and interpolation module, such as the multi-stage CFR and interpolation module 220 described with reference to FIGS. 2, 3, 5, 6, and/or 7.

At block 1125, digital pre-distortion may be performed on an output of the combined CFR/interpolation stages. The digital pre-distortion may in some cases be performed at a digital pre-distortion circuit, such as the digital pre-distortion module 630 described with reference to FIG. 6.

At block 1130, I/Q imbalance compensation may be performed on an output of the digital pre-distortion circuit. The I/Q imbalance compensation may in some cases be performed at an I/Q imbalance compensation circuit, such as the I/Q imbalance compensation module 635 described with reference to FIG. 6.

At block 1135, equalization is performed on an output of the I/Q imbalance compensation circuit. The equalization may in some cases be performed at a transmitter equalizer, such as the transmitter equalizer 640 described with reference to FIG. 6.

At block 1140, digital-to-analog conversion may be performed on an output of the transmitter equalizer. The digital-to-analog conversion may in some cases be performed at a DAC, such as the DAC 645 described with reference to FIG. 6.

At block 1145, analog filtering and I/Q modulation may be performed on an output of the DAC. The analog filtering and I/Q modulation may in some cases be performed at an RF module, such as the RF module 515 described with reference to FIGS. 5 and/or 6.

At block 1150, an output of the I/Q modulation is transmitted over the wireless channel. The transmission may in some cases be performed at a power amplifier, such as the power amplifier 520 described with reference to FIGS. 5 and/or 6.

Thus, the method 1100 may perform crest factor reduction and interpolation on a signal to be transmitted on a wireless channel. It should be noted that the method 1100 is just one implementation and that the operations of the method 1100 may be rearranged or otherwise modified such that other implementations are possible.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. At the Physical layer, the transport channels may be mapped to Physical channels.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with at least one processor, such as a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

A computer program product or computer-readable media includes both computer-readable storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein, but is to be accorded the widest scope consistent with the principles and novel features disclosed herein.

What is claimed is:

1. A method of performing combined crest factor reduction and interpolation on a signal to be transmitted on a wireless channel, comprising:
receiving, at each stage of a plurality of stages in a transmitter of a wireless device, a sample based on the signal to be transmitted on the wireless channel;
clipping the sample at each of the stages to produce a clipped version of the sample for that stage;
upsampling the clipped version of the sample for each of the stages to produce an upsampled and clipped version of the sample for that stage; and
processing the upsampled and clipped version of the sample for each of the stages with a complex filter implementing a combination of crest factor reduction filtering and interpolation filtering of the upsampled and clipped version of the sample for that stage.

2. The method of claim 1, further comprising:
determining a first filtering function for each of the stages, the first filtering function configured to perform the crest factor reduction filtering of the upsampled and clipped version of the sample for that stage; and
determining a set of taps for the complex filter at each of the stages based at least in part on the first filtering function for that stage.

3. The method of claim 2, further comprising:
determining a second filtering function for each of the stages, the second filtering function configured to perform the interpolation filtering of the upsampled and clipped version of the sample for that stage;
wherein the set of taps for the complex filter at each of the stages is further determined based at least in part on the second filtering function for that stage.

4. The method of claim 3, wherein the set of taps for the complex filter for at least two of the stages are different.

5. The method of claim 3, further comprising:
identifying a parameter of the signal to be transmitted on the wireless channel; and
modifying the set of taps for the complex filter of one of the stages based at least in part on the parameter of the signal to be transmitted on the wireless channel.

6. The method of claim 5, wherein the parameter comprises a bandwidth of the wireless channel, the method further comprising:
identifying a change in the bandwidth at the wireless device; and
modifying the first filtering function and the second filtering function for the one of the stages based on the change in the bandwidth;
wherein the modifying the set of taps for the complex filter of the one of the stages is based on the modifying the first filtering function and the second filtering function for the one of the stages.

7. The method of claim 5, wherein the parameter comprises a radio access technology (RAT) associated with the wireless channel, the method further comprising:
identifying a change in the RAT at the wireless device; and
modifying the first filtering function and the second filtering function for the one of the stages based on the change in the RAT;
wherein the modifying the set of taps for the complex filter of the one of the stages is based on the modifying the first filtering function and the second filtering function for the one of the stages.

8. The method of claim 5, wherein the parameter comprises an out-of-band (OOB) emission requirement associated with the wireless channel, the method further comprising:
identifying a change in the OOB emission requirement at the wireless device; and
modifying the first filtering function and the second filtering function for the one of the stages based on the change in the OOB emission requirement;
wherein the modifying the set of taps for the complex filter of the one of the stages is based on the modifying the first filtering function and the second filtering function for the one of the stages.

9. The method of claim 5, wherein the parameter comprises an error vector magnitude (EVM) associated with the wireless channel, the method further comprising:
identifying a change in the EVM at the wireless device; and
modifying the first filtering function and the second filtering function for the one of the stages based on the change in the EVM;
wherein the modifying the set of taps for the complex filter of the one of the stages is based on the modifying the first filtering function and the second filtering function for the one of the stages.

10. The method of claim 1, wherein the stages are cascaded.

11. The method of claim 1, wherein an output of the complex filter for each of the stages comprises a lower peak-to-average power ratio (PAPR) than the sample received at that stage.

12. The method of claim 1, further comprising:
determining a clipping amplitude for each of the stages;
wherein the clipping the sample for each of the stages is based on the clipping amplitude for that stage.

13. The method of claim 12, wherein the clipping the sample at each of the stages comprises:
computing a Look Up Table (LUT) input for each of the stages based on a difference between a squared absolute value of the sample received at that stage and a square of the clipping amplitude for that stage.

14. The method of claim 13, further comprising:
providing the LUT input computed for each of the stages to a LUT of that stage; and
computing the clipped version of the sample received at each of the stages based on an output of the LUT of that stage and the sample received at that stage.

15. The method of claim 1, further comprising:
performing the combined crest factor reduction and interpolation filtering of the sample at a digital front end of the transmitter of the wireless device.

16. The method of claim 1, wherein the clipping comprises one or more of: polar clipping, hard clipping, soft clipping, or peak smoothing.

17. A wireless modem, comprising:
a plurality of stages, each of the stages configured to receive a sample based on a signal to be transmitted on a wireless channel;
a clipper at each of the stages configured to clip the sample to produce a clipped version of the sample for that stage;
an upsampler at each of the stages configured to upsample the clipped version of the sample to produce an upsampled and clipped version of the sample for that stage; and
a filter at each of the stages configured to perform a combined crest factor reduction filtering and interpolation filtering on the upsampled and clipped version of the sample for that stage.

18. The wireless modem of claim 17, further comprising:
a crest factor reduction updating module configured to:
determine a first filtering function for each of the stages, the first filtering function configured to perform the crest factor reduction filtering of the upsampled and clipped version of the sample for that stage; and
determine a set of taps for the filter at each of the stages based at least in part on the first filtering function for that stage.

19. The wireless modem of claim 18, wherein the crest factor reduction updating module is further configured to:
determine a second filtering function for each of the stages, the second filtering function configured to perform the interpolation filtering of the upsampled and clipped version of the sample for that stage; and
further determine the set of taps for the filter at each of the stages based at least in part on the second filtering function for that stage.

20. A non-transitory computer-readable medium storing instructions executable by a processor to:
receive, at each stage of a plurality of cascaded stages in a transmitter of a wireless device, a sample based on the signal to be transmitted on the wireless channel;
clip the sample at each of the stages to produce a clipped version of the sample for that stage;
upsample the clipped version of the sample for each of the stages to produce an upsampled and clipped version of the sample for that stage; and
process the upsampled and clipped version of the sample for each of the stages with a filter implementing a combination of crest factor reduction filtering and interpolation filtering of the upsampled and clipped version of the sample for that stage.
